(19) United States
(12) Patent Application Publication
(10) Pub. No.: US 2026/0208441 A1
(43) Pub. Date: Jul. 23, 2026

(54) WASTE REMOVAL FOR THREE-DIMENSIONAL PRINTING

(71) Applicant: Stratasys Ltd., Rehovot (IL)

(72) Inventors: Vitali KRASNOPOLSKY, Rishon LeZion (IL); Artur SOLDATENKO, Yad Hana (IL)

(73) Assignee: Stratasys Ltd., Rehovot (IL)

(21) Appl. No.: 19/144,477

(22) PCT Filed: Dec. 17, 2023
(86) PCT No.: PCT/IL2023/051280

§ 371 Date: Jun. 29, 2025

Related U.S. Application Data
(60) Provisional application No. 63/436,145, filed on Dec. 30, 2022.

(51) Int. Cl. B29C 64/30; B29C 64/124; B29C 64/188; B29C 64/209; B33Y 30/00; B33Y 40/00

(52) U.S. Cl. CPC B29C 64/30; B29C 64/124; B29C 64/188; B29C 64/209; B33Y 30/00; B33Y 40/00

(57) ABSTRACT

A waste collecting system comprises a bath for collecting liquid waste from the leveling device, a bath cover covering the bath, and a waste removal pipe sealingly passing through the cover and being configured to generate under-pressure in an interior of the bath so as to suck the liquid waste out of the bath. The waste collecting system is useful for collecting waste from a leveling device of a three-dimensional printing system.

### RELATED APPLICATION

This application claims the benefit of priority of U.S. Provisional Patent Application No. 63/436,145 filed on Dec. 30, 2022, the contents of which are incorporated herein by reference in their entirety.

### FIELD AND BACKGROUND OF THE INVENTION

The present invention, in some embodiments thereof, relates to three-dimensional printing and, more particularly, but not exclusively, to a waste removal system for three-dimensional printing.

Additive manufacturing (AM) is a technology enabling fabrication of shaped structures directly from computer data via additive formation steps. The basic operation of any AM system consists of slicing a three-dimensional computer model into thin cross sections, translating the result into two-dimensional position data and feeding the data to control equipment which fabricates a three-dimensional structure in a layerwise manner.

Additive manufacturing entails many different approaches to the method of fabrication, including three-dimensional (3D) printing such as 3D inkjet printing, electron beam melting, stereolithography, selective laser sintering, laminated object manufacturing, fused deposition modeling and others.

Some 3D printing processes, for example, 3D inkjet printing, are being performed by a layer by layer inkjet deposition of building materials. Thus, an uncured building material is dispensed from a dispensing head having a set of nozzles to deposit layers on a supporting structure. The layers are then cured by curing radiation emitted by a radiation.

Various three-dimensional printing techniques exist and are disclosed in, e.g., U.S. Pat. Nos. 6,259,979, 6,569,373, 6,658,314, 6,850,334, 6,863,859, 7,183,335, 7,209,797, 7,225,045, 7,300,619, 7,500,846, 9,031,680 and 9,227,365, U.S. Published Application No. 20060054039, and International publication No. WO2016/009426, all by the same Assignee, and being hereby incorporated by reference in their entirety.

### SUMMARY OF THE INVENTION

According to an aspect of some embodiments of the invention the present invention there is provided a waste collecting system for a leveling device of a three-dimensional printing system. The waste collecting system comprises a bath for collecting liquid waste from the leveling device, a bath cover covering the bath, and a waste removal pipe sealingly passing through the cover and being configured to generate under-pressure in an interior of the bath so as to suck the liquid waste out of the bath.

According to some embodiments of the invention the system comprises a manifold having an outlet port connected to the waste removal pipe, and a plurality of inlet ports in fluid communication with the interior, wherein the under-pressure is generated at each of the plurality of inlet ports.

According to some embodiments of the invention the system comprises a plurality of secondary pipes, each having a proximal side connected to one of the inlet ports and being positioned such that a distal side thereof contacts the liquid waste in the bath.

According to some embodiments of the invention the system comprises a connector for connecting the waste removal pipe to the cover.

According to an aspect of some embodiments of the present invention there is provided a system for three-dimensional printing. The system comprises: an array of nozzles for dispensing building materials in layers; a leveling device configured for leveling newly formed layers; the waste collecting system as delineated above and optionally and preferably as further detailed below; a pump system connected to the pipe; and a computerized controller configured for operating at least the array of nozzles.

According to some embodiments of the invention the controller is configured to activate and deactivate the pump.

According to an aspect of some embodiments of the present invention there is provided a method of collecting liquid waste from a leveling device of a three-dimensional printing system. The method comprises applying under-pressure to a waste removal pipe sealingly passing through a sealed cover of a bath collecting the liquid waste from the leveling device, so as to suck the liquid waste out of the bath.

According to some embodiments of the invention the waste removal pipe is connected to the cover by a connector.

According to some embodiments of the invention the waste removal pipe is connected to an outlet port of a manifold, wherein the manifold comprises a plurality of inlet ports in fluid communication with an interior of the bath, and wherein the under-pressure is generated at each of the plurality of inlet ports.

According to some embodiments of the invention each inlet port is connected to a proximal side of a secondary pipe having a distal side contacting the liquid waste in the bath.

According to some embodiments of the invention at least one of the secondary pipes is straight. According to some embodiments of the invention all the secondary pipes are straight.

According to some embodiments of the invention at least one of the secondary pipes has a uniform diameter along its entire length.

According to some embodiments of the invention each of the secondary pipes has a uniform diameter along its entire length.

According to some embodiments of the invention the manifold includes no more than two inlet ports.

According to some embodiments of the invention the connector is an O-ring.

According to an aspect of some embodiments of the present invention there is provided a method of three-dimensional printing. The method comprises: dispensing a modeling material to form a plurality of layers arranged in a configured pattern corresponding to a shape of an object; leveling at least one of the layers by a leveling device; collecting liquid waste from the leveling device into a bath; and executing the method as delineated above and optionally and preferably as further detailed below to remove the liquid waste from the bath.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIGS. 1A-D are schematic illustrations of an additive manufacturing system according to some embodiments of the invention;

FIGS. 2A-2C are schematic illustrations of printing heads according to some embodiments of the present invention;

FIGS. 3A and 3B are schematic illustrations demonstrating coordinate transformations according to some embodiments of the present invention; and

FIGS. 4A and 4B are schematic illustrations of a waste collection system according to some embodiments of the present invention, where FIG. 4A is a perspective view of the waste collection system, and FIG. 4B is a cross-sectional view along the line B-B of FIG. 4A.

### DESCRIPTION OF SPECIFIC EMBODIMENTS OF THE INVENTION

The present invention, in some embodiments thereof, relates to three-dimensional printing and, more particularly, but not exclusively, to a waste removal system for three-dimensional printing.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The method and system of the present embodiments manufacture three-dimensional objects based on computer object data in a layerwise manner by forming a plurality of layers in a configured pattern corresponding to the shape of the objects. The computer object data can be in any known format, including, without limitation, a Standard Tessellation Language (STL) or a StereoLithography Contour (SLC) format, an OBJ File format (OBJ), a 3D Manufacturing Format (3MF), Virtual Reality Modeling Language (VRML), Additive Manufacturing File (AMF) format, Drawing Exchange Format (DXF), Polygon File Format (PLY), 3D Manufacturing Format (3MF), Object file format (OBJ), or any other format suitable for Computer-Aided Design (CAD).

The term “object” as used herein refers to a whole object or a part thereof.

Each layer is formed by an additive manufacturing apparatus which scans a two-dimensional surface and patterns it. While scanning, the apparatus visits a plurality of target locations on the two-dimensional layer or surface, and decides, for each target location or a group of target locations, whether or not the target location or group of target locations is to be occupied by building material formulation, and which type of building material formulation is to be delivered thereto. The decision is made according to a computer image of the surface.

In preferred embodiments of the present invention the AM comprises three-dimensional printing, more preferably three-dimensional inkjet printing. In these embodiments a building material is dispensed from a printing head having one or more arrays of nozzles to deposit building material in layers on a supporting structure. The AM apparatus thus dispenses building material in target locations which are to be occupied and leaves other target locations void. The apparatus typically includes a plurality of arrays of nozzles, each of which can be configured to dispense a different building material. This is typically achieved by providing the printing head with a plurality of fluid channels are separated from each other such that there is no fluid communication therebetween, wherein each channel receives a different building material through a separate inlet and conveys it to a different array of nozzles.

Thus, different target locations can be occupied by different building material formulations. The types of building material formulations can be categorized into two major categories: modeling material formulation and support material formulation. The support material formulation serves as a supporting matrix or construction for supporting the object or object parts during the fabrication process and/or other purposes, e.g., providing hollow or porous objects. Support constructions may additionally include modeling material formulation elements, e.g. for further support strength.

The modeling material formulation is generally a composition which is formulated for use in additive manufacturing and which is able to form a three-dimensional object on its own, i.e., without having to be mixed or combined with any other substance.

The final three-dimensional object is made of the modeling material formulation or a combination of modeling material formulations or modeling and support material formulations or modification thereof (e.g., following curing). All these operations are well-known to those skilled in the art of solid freeform fabrication.

In some exemplary embodiments of the invention an object is manufactured by dispensing two or more different modeling material formulations, each material formulation from a different array of nozzles (belonging to the same or different printing heads) of the AM apparatus. In some embodiments, two or more such arrays of nozzles that dispense different modeling material formulations are both located in the same printing head of the AM apparatus. In some embodiments, arrays of nozzles that dispense different modeling material formulations are located in separate printing heads, for example, a first array of nozzles dispensing a first modeling material formulation is located in a first printing head, and a second array of nozzles dispensing a second modeling material formulation is located in a second printing head.

In some embodiments, an array of nozzles that dispense a modeling material formulation and an array of nozzles that dispense a support material formulation are both located in the same printing head. In some embodiments, an array of nozzles that dispense a modeling material formulation and an array of nozzles that dispense a support material formulation are located in separate printing heads.

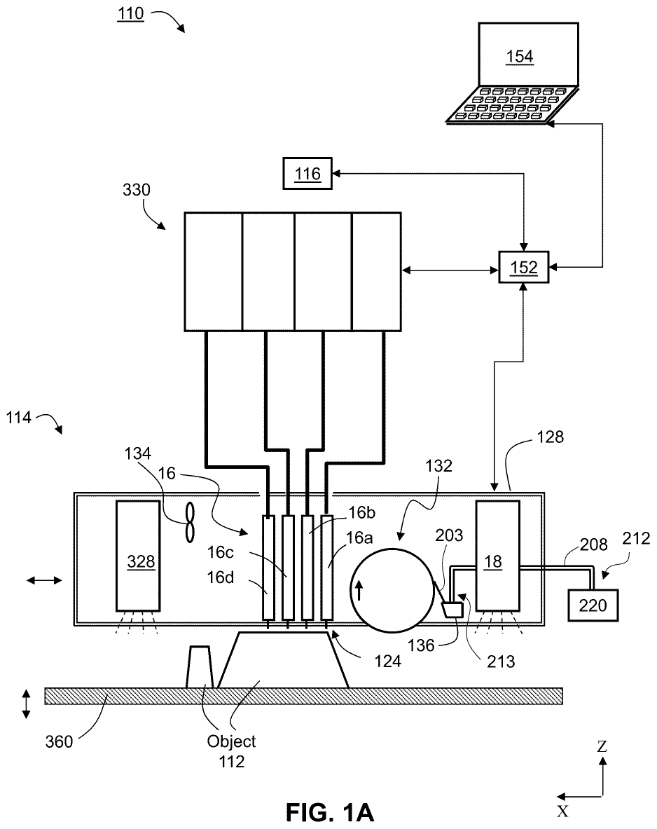

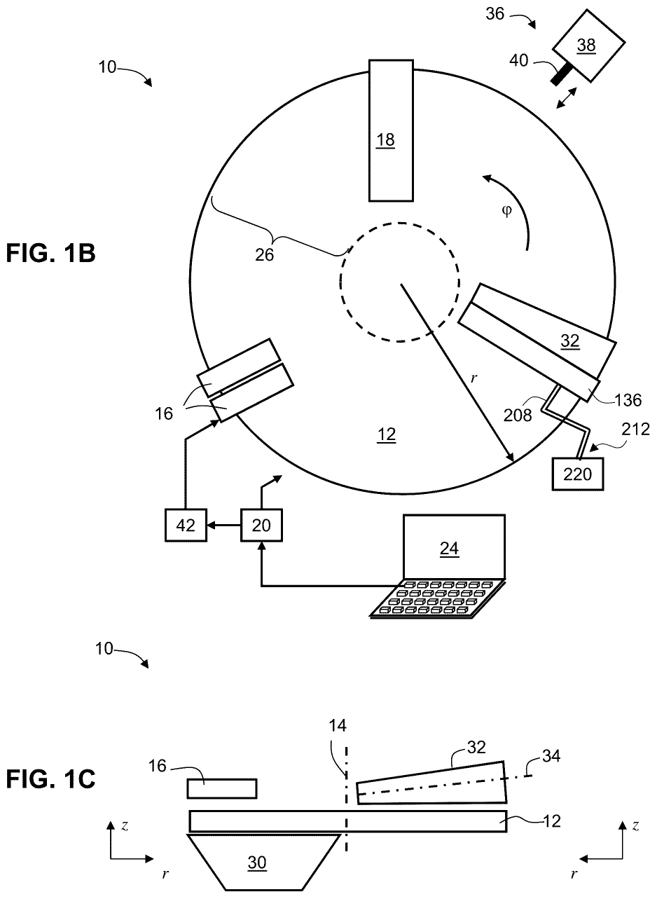

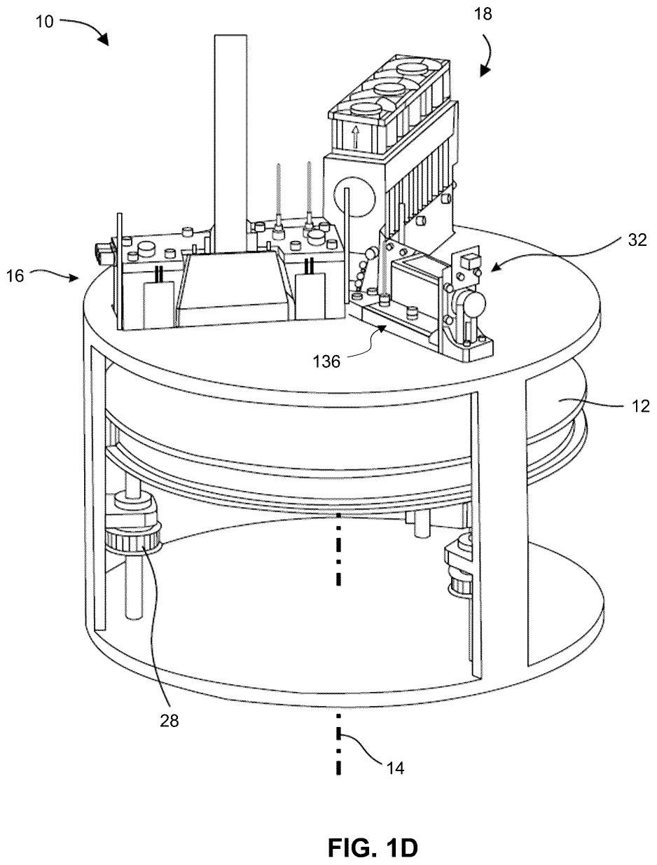

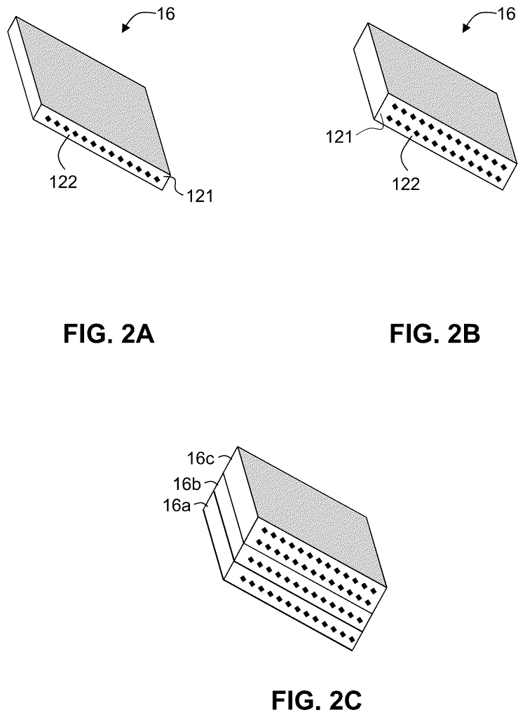

A representative and non-limiting example of a system 110 suitable for AM of an object 112 according to some embodiments of the present invention is illustrated in FIG. 1A. System 110 comprises an additive manufacturing apparatus 114 having a dispensing unit 16 which comprises a plurality of printing heads. Each head preferably comprises one or more arrays of nozzles 122, typically mounted on an orifice plate 121, as illustrated in FIGS. 2A-C described below, through which a liquid building material formulation 124 is dispensed.

Preferably, but not obligatorily, apparatus 114 is a three-dimensional printing apparatus, in which case the printing heads are printing heads, and the building material formulation is dispensed via inkjet technology. This need not necessarily be the case, since, for some applications, it may not be necessary for the additive manufacturing apparatus to employ three-dimensional printing techniques. Representative examples of additive manufacturing apparatus contemplated according to various exemplary embodiments of the present invention include, without limitation, fused deposition modeling apparatus and fused material formulation deposition apparatus.

Each printing head is optionally and preferably fed via one or more building material formulation reservoirs which may optionally include a temperature control unit (e.g., a temperature sensor and/or a heating device), and a material formulation level sensor. To dispense the building material formulation, a voltage signal is applied to the printing heads to selectively deposit droplets of material formulation via the printing head nozzles, for example, as in piezoelectric inkjet printing technology. Another example includes thermal inkjet printing heads. In these types of heads, there are heater elements in thermal contact with the building material formulation, for heating the building material formulation to form gas bubbles therein, upon activation of the heater elements by a voltage signal. The gas bubbles generate pressures in the building material formulation, causing droplets of building material formulation to be ejected through the nozzles. Piezoelectric and thermal printing heads are known to those skilled in the art of solid freeform fabrication. For any types of inkjet printing heads, the dispensing rate of the head depends on the number of nozzles, the type of nozzles and the applied voltage signal rate (frequency).

In an embodiment of the invention, the overall number of dispensing nozzles or nozzle arrays is selected such that half of the dispensing nozzles are designated to dispense support material formulation and half of the dispensing nozzles are designated to dispense modeling material formulation, i.e. the number of nozzles jetting modeling material formulations is the same as the number of nozzles jetting support material formulation. The ratio of modeling material dispensing arrays to support material dispensing arrays may vary. In the representative example of FIG. 1A, four printing heads 16a, 16b, 16c and 16d are illustrated. Each of heads 16a, 16b, 16c and 16d has a nozzle array. In this Example, heads 16a and 16b can be designated for modeling material formulation/s and heads 16c and 16d can be designated for support material formulation. Thus, head 16a can dispense one modeling material formulation, head 16b can dispense another modeling material formulation and heads 16c and 16d can both dispense support material formulation. In an alternative embodiment, heads 16c and 16d, for example, may be combined in a single head having two nozzle arrays for depositing support material formulation. In a further alternative embodiment any one or more of the printing heads may have more than one nozzle arrays for depositing more than one material formulation, e.g. two nozzle arrays for depositing two different modeling material formulations or a modeling material formulation and a support material formulation, each formulation via a different array or number of nozzles.

Yet it is to be understood that it is not intended to limit the scope of the present invention and that the number of modeling material formulation printing heads (modeling heads) and the number of support material formulation printing heads (support heads) may differ. Generally, the number of arrays of nozzles that dispense modeling material formulation, the number of arrays of nozzles that dispense support material formulation, and the number of nozzles in each respective array are selected such as to provide a predetermined ratio, a, between the maximal dispensing rate of the support material formulation and the maximal dispensing rate of modeling material formulation. The value of the predetermined ratio, a, is preferably selected to ensure that in each formed layer, the height of modeling material formulation equals the height of support material formulation. Typical values for a are from about 0.6 to about 1.5.

As used herein throughout the term “about” refers to ±10%.

For example, for a =1, the overall dispensing rate of support material formulation is generally the same as the overall dispensing rate of the modeling material formulation when all the arrays of nozzles operate.

Apparatus 114 can comprise, for example, M modeling heads each having m arrays of p nozzles, and S support heads each having s arrays of q nozzles such that M×m×p=S×s×q. Each of the M×m modeling arrays and S×s support arrays can be manufactured as a separate physical unit, which can be assembled and disassembled from the group of arrays. In this embodiment, each such array optionally and preferably comprises a temperature control unit and a material formulation level sensor of its own, and receives an individually controlled voltage for its operation.

Apparatus 114 can further comprise one or more solidifying devices 18 each can include any device configured to emit light, heat or the like that may cause the deposited material formulation to harden. For example, solidifying device 18 can comprise one or more radiation sources, which can be, for example, an ultraviolet or visible or infrared lamp, or other sources of electromagnetic radiation, or electron beam source, depending on the modeling material formulation being used. The radiation source can in some embodiments of the present invention be selected from the group consisting of a light emitting diode (LED), a digital light processing (DLP) system, a resistive lamp and the like. In some embodiments of the present invention, solidifying device 18 serves for curing or solidifying the modeling material formulation.

In addition to solidifying device 18, apparatus 114 optionally and preferably comprises an additional radiation source 328. Radiation source 328 can be the same as the radiation source employed by device 18 (e.g., an ultraviolet radiation source) or it can be configured to effect solvent evaporation, in which case it optionally and preferably generates infrared radiation.

In some embodiments of the present invention apparatus 114 comprises cooling system 134 such as one or more fans or the like.

The printing head(s) and radiation source are preferably mounted in a frame or block 128 which is preferably operative to reciprocally move over a tray 360, which serves as the working surface. In some embodiments of the present invention the radiation sources are mounted in the block such that they follow in the wake of the printing heads to at least partially cure or solidify the material formulations just dispensed by the printing heads. Tray 360 is positioned horizontally. According to the common conventions an X-Y-Z Cartesian coordinate system is selected such that the X-Y plane is parallel to tray 360. Tray 360 is preferably configured to move vertically (along the Z direction), typically downward. In various exemplary embodiments of the invention, apparatus 114 further comprises one or more leveling devices 32, such as a roller or a blade. Leveling device 32 serves to straighten, level and/or establish a thickness of the newly formed layer prior to the formation of the successive layer thereon.

System 110 preferably comprises a waste collection system 136 for collecting the excess material formulation generated during leveling. Waste collection system 136 may comprise any mechanism that delivers the material formulation to a waste bath. Liquid waste is removed from the waste bath of collection system 136 by means of a pipe 208 connected to a pump 220 that applies suction to the liquid waste in the bath. In conventional waste collection systems for three-dimensional printing, the inlet port of the suctioning pipe is located at a specific location on the base of the waste bath (typically at the center thereof) and so the suction is applied locally at the location of the inlet port. The inventors found that such suction leaves remnants of liquid waste at locations within the waste bath that are farther away from the suctioning point. The inventors found that such an incomplete removal of the liquid waste creates a problem because the waste may solidify in the bath making it more difficult to remove it. The inventors also found that the presence of solidified waste in the bath can also form pockets which may block the flow path of newly arrived liquid waste into the suctioning pipe thus further preventing the waste removal. As a result, the amount of unremovable waste in the bath aggregates with time.

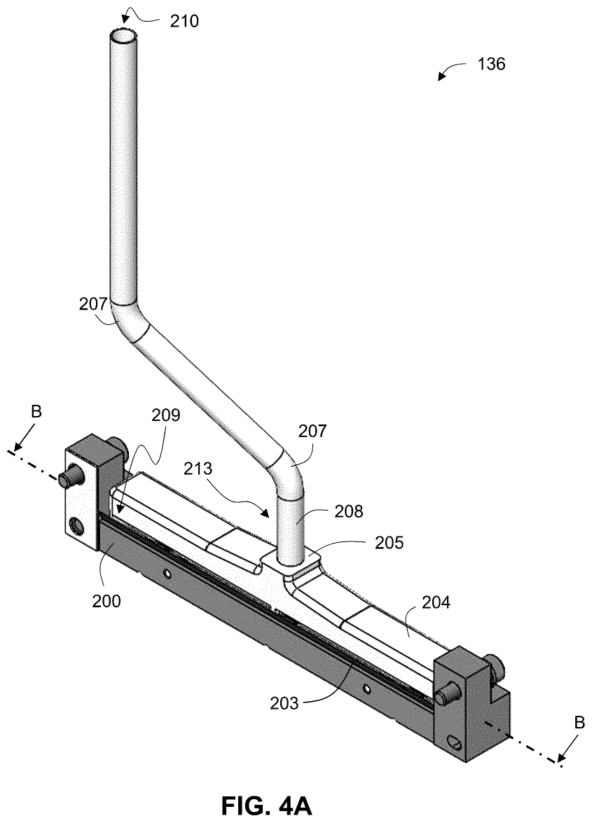

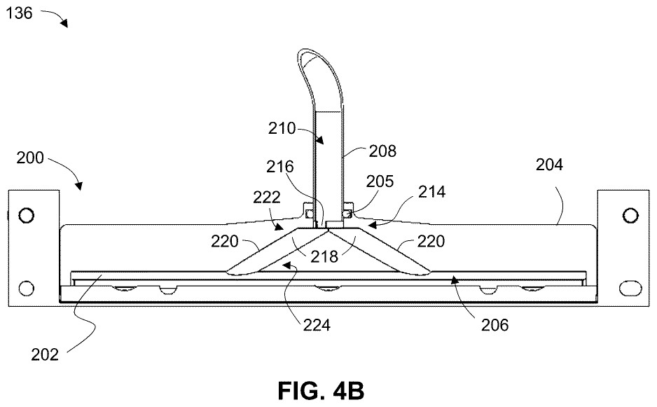

The Inventors contemplated and successfully reduced to practice a collection system 136 in which the under-pressure is generated more efficiently throughout the volume of the waste bath thereby reducing the likelihood of incomplete removal of waste. A more detailed description of waste collection system 136 is provided hereinbelow with reference to FIGS. 4A-B.

In use, the printing heads of unit 16 move in a scanning direction, which is referred to herein as the X direction, and selectively dispense building material formulation in a predetermined configuration in the course of their passage over tray 360. The building material formulation typically comprises one or more types of support material formulation and one or more types of modeling material formulation. The passage of the printing heads of unit 16 is followed by the curing of the modeling material formulation(s) by radiation source 126. In the reverse passage of the heads, back to their starting point for the layer just deposited, an additional dispensing of building material formulation may be carried out, according to predetermined configuration. In the forward and/or reverse passages of the printing heads, the layer thus formed may be straightened by leveling device 326, which preferably follows the path of the printing heads in their forward and/or reverse movement. Once the printing heads return to their starting point along the X direction, they may move to another position along an indexing direction, referred to herein as the Y direction, and continue to build the same layer by reciprocal movement along the X direction. Alternately, the printing heads may move in the Y direction between forward and reverse movements or after more than one forward-reverse movement. The series of scans performed by the printing heads to complete a single layer is referred to herein as a single scan cycle.

Once the layer is completed, tray 360 is lowered in the Z direction to a predetermined Z level, according to the desired thickness of the layer subsequently to be printed. The procedure is repeated to form three-dimensional object 112 in a layerwise manner.

In another embodiment, tray 360 may be displaced in the Z direction between forward and reverse passages of the printing head of unit 16, within the layer. Such Z displacement is carried out in order to cause contact of the leveling device with the surface in one direction and prevent contact in the other direction.

System 110 optionally and preferably comprises a building material formulation supply system 330 which comprises the building material formulation containers or cartridges and supplies a plurality of building material formulations to fabrication apparatus 114.

A controller 20 controls fabrication apparatus 114 and optionally and preferably also supply system 330. Controller 20 typically includes an electronic circuit configured to perform the controlling operations. Controller 20 preferably communicates with a data processor 24 which transmits digital data pertaining to fabrication instructions based on computer object data, e.g., a CAD configuration represented on a computer readable medium in a form of a Standard Tessellation Language (STL) format or the like. Typically, controller 20 controls the voltage applied to each printing head or each nozzle array and the temperature of the building material formulation in the respective printing head or respective nozzle array.

Once the manufacturing data is loaded to controller 20 it can operate without user intervention. In some embodiments, controller 20 receives additional input from the operator, e.g., using data processor 24 or using a user interface 116 communicating with controller 20. User interface 116 can be of any type known in the art, such as, but not limited to, a keyboard, a touch screen and the like. For example, controller 20 can receive, as additional input, one or more building material formulation types and/or attributes, such as, but not limited to, color, characteristic distortion and/or transition temperature, viscosity, electrical property, magnetic property. Other attributes and groups of attributes are also contemplated.

Another representative and non-limiting example of a system 10 suitable for AM of an object according to some embodiments of the present invention is illustrated in FIGS. 1B-D. FIG. 1B-D illustrate a top view (FIG. 1B), a side view (FIG. 1C) and an isometric view (FIG. 1D) of system 10.

In the present embodiments, system 10 comprises a tray 12 and a plurality of inkjet printing heads 16, each having one or more arrays of nozzles with respective one or more pluralities of separated nozzles. The material used for the three-dimensional printing is supplied to heads 16 by a building material supply system 42. Tray 12 can have a shape of a disk or it can be annular. Non-round shapes are also contemplated, provided they can be rotated about a vertical axis.

Tray 12 and heads 16 are optionally and preferably mounted such as to allow a relative rotary motion between tray 12 and heads 16. This can be achieved by (i) configuring tray 12 to rotate about a vertical axis 14 relative to heads 16, (ii) configuring heads 16 to rotate about vertical axis 14 relative to tray 12, or (iii) configuring both tray 12 and heads 16 to rotate about vertical axis 14 but at different rotation velocities (e.g., rotation at opposite direction). While some embodiments of system 10 are described below with a particular emphasis to configuration (i) wherein the tray is a rotary tray that is configured to rotate about vertical axis 14 relative to heads 16, it is to be understood that the present application contemplates also configurations (ii) and (iii) for system 10. Any one of the embodiments of system 10 described herein can be adjusted to be applicable to any of configurations (ii) and (iii), and one of ordinary skills in the art, provided with the details described herein, would know how to make such adjustment.

In the following description, a direction parallel to tray 12 and pointing outwardly from axis 14 is referred to as the radial direction r, a direction parallel to tray 12 and perpendicular to the radial direction r is referred to herein as the azimuthal direction, and a direction perpendicular to tray 12 is referred to herein is the vertical direction z.

The radial direction r in system 10 enacts the indexing direction y in system 110, and the azimuthal direction φ enacts the scanning direction x in system 110. Therefore, the radial direction is interchangeably referred to herein as the indexing direction, and the azimuthal direction is interchangeably referred to herein as the scanning direction.

The term “radial position,” as used herein, refers to a position on or above tray 12 at a specific distance from axis 14. When the term is used in connection to a printing head, the term refers to a position of the head which is at specific distance from axis 14. When the term is used in connection to a point on tray 12, the term corresponds to any point that belongs to a locus of points that is a circle whose radius is the specific distance from axis 14 and whose center is at axis 14.

The term “azimuthal position,” as used herein, refers to a position on or above tray 12 at a specific azimuthal angle relative to a predetermined reference point. Thus, radial position refers to any point that belongs to a locus of points that is a straight line forming the specific azimuthal angle relative to the reference point.

The term “vertical position,” as used herein, refers to a position over a plane that intersect the vertical axis 14 at a specific point.

Tray 12 serves as a building platform for three-dimensional printing. The working area on which one or objects are printed is typically, but not necessarily, smaller than the total area of tray 12. In some embodiments of the present invention the working area is annular. The working area is shown at 26. In some embodiments of the present invention tray 12 rotates continuously in the same direction throughout the formation of object, and in some embodiments of the present invention tray reverses the direction of rotation at least once (e.g., in an oscillatory manner) during the formation of the object. Tray 12 is optionally and preferably removable. Removing tray 12 can be for maintenance of system 10, or, if desired, for replacing the tray before printing a new object. In some embodiments of the present invention system 10 is provided with one or more different replacement trays (e.g., a kit of replacement trays), wherein two or more trays are designated for different types of objects (e.g., different weights) different operation modes (e.g., different rotation speeds), etc. The replacement of tray 12 can be manual or automatic, as desired. When automatic replacement is employed, system 10 comprises a tray replacement device 36 configured for removing tray 12 from its position below heads 16 and replacing it by a replacement tray (not shown). In the representative illustration of FIG. 1B tray replacement device 36 is illustrated as a drive 38 with a movable arm 40 configured to pull tray 12, but other types of tray replacement devices are also contemplated.

Exemplified embodiments for the printing head 16 are illustrated in FIGS. 2A-2C. These embodiments can be employed for any of the AM systems described above, including, without limitation, system 110 and system 10.

FIGS. 2A-B illustrate a printing head 16 with one (FIG. 2A) and two (FIG. 2B) nozzle arrays 22. The nozzles in the array are preferably aligned linearly, along a straight line. In embodiments in which a particular printing head has two or more linear nozzle arrays, the nozzle arrays are optionally and preferably can be parallel to each other. When a printing head has two or more arrays of nozzles (e.g., FIG. 2B) all arrays of the head can be fed with the same building material formulation, or at least two arrays of the same head can be fed with different building material formulations.

When a system similar to system 110 is employed, all printing heads 16 are optionally and preferably oriented along the indexing direction with their positions along the scanning direction being offset to one another.

When a system similar to system 10 is employed, all printing heads 16 are optionally and preferably oriented radially (parallel to the radial direction) with their azimuthal positions being offset to one another. Thus, in these embodiments, the nozzle arrays of different printing heads are not parallel to each other but are rather at an angle to each other, which angle being approximately equal to the azimuthal offset between the respective heads. For example, one head can be oriented radially and positioned at azimuthal position φ₁, and another head can be oriented radially and positioned at azimuthal position φ₂. In this example, the azimuthal offset between the two heads is φ₁-φ₂, and the angle between the linear nozzle arrays of the two heads is also φ₁-φ₂.

In some embodiments, two or more printing heads can be assembled to a block of printing heads, in which case the printing heads of the block are typically parallel to each other. A block including several inkjet printing heads 16a, 16b, 16c is illustrated in FIG. 2C.

In some embodiments, system 10 comprises a stabilizing structure 30 positioned below heads 16 such that tray 12 is between stabilizing structure 30 and heads 16. Stabilizing structure 30 may serve for preventing or reducing vibrations of tray 12 that may occur while inkjet printing heads 16 operate. In configurations in which printing heads 16 rotate about axis 14, stabilizing structure 30 preferably also rotates such that stabilizing structure 30 is always directly below heads 16 (with tray 12 between heads 16 and tray 12).

Tray 12 and/or printing heads 16 is optionally and preferably configured to move along the vertical direction z, parallel to vertical axis 14 so as to vary the vertical distance between tray 12 and printing heads 16. In configurations in which the vertical distance is varied by moving tray 12 along the vertical direction, stabilizing structure 30 preferably also moves vertically together with tray 12. In configurations in which the vertical distance is varied by heads 16 along the vertical direction, while maintaining the vertical position of tray 12 fixed, stabilizing structure 30 is also maintained at a fixed vertical position.

The vertical motion can be established by a vertical drive 28. Once a layer is completed, the vertical distance between tray 12 and heads 16 can be increased (e.g., tray 12 is lowered relative to heads 16) by a predetermined vertical step, according to the desired thickness of the layer subsequently to be printed. The procedure is repeated to form a three-dimensional object in a layerwise manner.

The operation of inkjet printing heads 16 and optionally and preferably also of one or more other components of system 10, e.g., the motion of tray 12, are controlled by a controller 20. The controller can have an electronic circuit and a non-volatile memory medium readable by the circuit, wherein the memory medium stores program instructions which, when read by the circuit, cause the circuit to perform control operations as further detailed below.

Controller 20 can also communicate with a host computer 24 which transmits digital data pertaining to fabrication instructions based on computer object data, e.g., in a form of a Standard Tessellation Language (STL) or a StereoLithography Contour (SLC) format, Virtual Reality Modeling Language (VRML), Additive Manufacturing File (AMF) format, Drawing Exchange Format (DXF), Polygon File Format (PLY) or any other format suitable for Computer-Aided Design (CAD). The object data formats are typically structured according to a Cartesian system of coordinates. In these cases, computer 24 preferably executes a procedure for transforming the coordinates of each slice in the computer object data from a Cartesian system of coordinates into a polar system of coordinates. Computer 24 optionally and preferably transmits the fabrication instructions in terms of the transformed system of coordinates. Alternatively, computer 24 can transmit the fabrication instructions in terms of the original system of coordinates as provided by the computer object data, in which case the transformation of coordinates is executed by the circuit of controller 20.

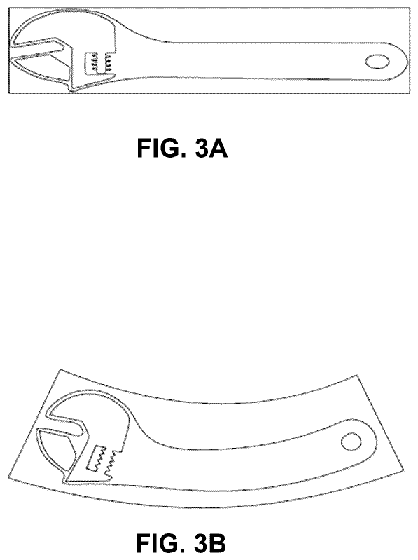

The transformation of coordinates allows three-dimensional printing over a rotating tray. In non-rotary systems with a stationary tray with the printing heads typically reciprocally move above the stationary tray along straight lines. In such systems, the printing resolution is the same at any point over the tray, provided the dispensing rates of the heads are uniform. In system 10, unlike non-rotary systems, not all the nozzles of the head points cover the same distance over tray 12 during at the same time. The transformation of coordinates is optionally and preferably executed so as to ensure equal amounts of excess material formulation at different radial positions. Representative examples of coordinate transformations according to some embodiments of the present invention are provided in FIGS. 3A-B, showing a slice of an object (corresponding to fabrication instructions of one layer of the object), where FIG. 3A illustrates a slice in a Cartesian system of coordinates and FIG. 3B illustrates the same slice following an application of a transformation of coordinates procedure to the respective slice.

Typically, controller 20 controls the voltage applied to the respective component of the system 10 based on the fabrication instructions and based on the stored program instructions as described below.

Generally, controller 20 controls printing heads 16 to dispense, during the rotation of tray 12, droplets of building material formulation in layers, such as to print a three-dimensional object on tray 12.

System 10 optionally and preferably comprises one or more solidifying devices 18, each can be, the same or similar to the solidifying device described above with respect to system 110, and may also include a radiation shield 325 (not shown, see FIG. 1A), as further detailed hereinabove.

In various exemplary embodiments of the invention the operation of solidifying device 18 is controlled by controller 20 which may activate and deactivate the radiation source of solidifying device 18 and may optionally also control the amount of radiation generated by solidifying device 18.

In some embodiments of the invention, system 10 further comprises one or more leveling devices 32 which can be manufactured as a roller or a blade. Leveling device 32 serves to straighten the newly formed layer prior to the formation of the successive layer thereon. System 10 preferably comprises a waste collection system 136 for collecting the excess material formulation generated during leveling. Waste collection system 136 may comprise any mechanism that delivers the material formulation to a waste tank or waste cartridge. Liquid waste is removed from the waste bath of collection system 136 by means of a pipe 208 connected to a pump 220 that applies suction to the liquid waste in the bath, as further detailed herein.

In some embodiments, leveling device 32 has the shape of a conical roller positioned such that its symmetry axis 34 is tilted relative to the surface of tray 12 and its surface is parallel to the surface of the tray. This embodiment is illustrated in the side view of system 10 (FIG. 1C).

The conical roller can have the shape of a cone or a conical frustum.

The opening angle of the conical roller is preferably selected such that there is a constant ratio between the radius of the cone at any location along its axis 34 and the distance between that location and axis 14. This embodiment allows roller 32 to efficiently level the layers, since while the roller rotates, any point p on the surface of the roller has a linear velocity which is proportional (e.g., the same) to the linear velocity of the tray at a point vertically beneath point p. In some embodiments, the roller has a shape of a conical frustum having a height h, a radius R₁ at its closest distance from axis 14, and a radius R₂ at its farthest distance from axis 14, wherein the parameters h, R₁ and R₂ satisfy the relation R₁/R₂=(R−h)/h and wherein R is the farthest distance of the roller from axis 14 (for example, R can be the radius of tray 12).

The operation of leveling device 32 is optionally and preferably controlled by controller 20 which may activate and deactivate leveling device 32 and may optionally also control its position along a vertical direction (parallel to axis 14) and/or a radial direction (parallel to tray 12 and pointing toward or away from axis 14.

In some embodiments of the present invention printing heads 16 are configured to reciprocally move relative to tray along the radial direction r. These embodiments are useful when the lengths of the nozzle arrays 22 of heads 16 are shorter than the width along the radial direction of the working area 26 on tray 12. The motion of heads 16 along the radial direction is optionally and preferably controlled by controller 20.

Some embodiments contemplate the fabrication of an object by dispensing different material formulations from different arrays of nozzles (belonging to the same or different printing head). These embodiments provide, inter alia, the ability to select material formulations from a given number of material formulations and define desired combinations of the selected material formulations and their properties. According to the present embodiments, the spatial locations of the deposition of each material formulation with the layer is defined, either to effect occupation of different three-dimensional spatial locations by different material formulations, or to effect occupation of substantially the same three-dimensional location or adjacent three-dimensional locations by two or more different material formulations so as to allow post deposition spatial combination of the material formulations within the layer, thereby to form a composite material formulation at the respective location or locations.

Any post deposition combination or mix of modeling material formulations is contemplated. For example, once a certain material formulation is dispensed it may preserve its original properties. However, when it is dispensed simultaneously with another modeling material formulation or other dispensed material formulations which are dispensed at the same or nearby locations, a composite material formulation having a different property or properties to the dispensed material formulations may be formed.

In some embodiments of the present invention the system dispenses digital material formulation for at least one of the layers.

The phrase “digital material formulations”, as used herein and in the art, describes a combination of two or more material formulations on a pixel level or voxel level such that pixels or voxels of different material formulations are interlaced with one another over a region. Such digital material formulations may exhibit new properties that are affected by the selection of types of material formulations and/or the ratio and relative spatial distribution of two or more material formulations.

As used herein, a “voxel” of a layer refers to a physical three-dimensional elementary volume within the layer that corresponds to a single pixel of a bitmap describing the layer. The size of a voxel is approximately the size of a region that is formed by a building material, once the building material is dispensed at a location corresponding to the respective pixel, leveled, and solidified.

The present embodiments thus enable the deposition of a broad range of material formulation combinations, and the fabrication of an object which may consist of multiple different combinations of material formulations, in different parts of the object, according to the properties desired to characterize each part of the object.

Further details on the principles and operations of an AM system suitable for the present embodiments are found in U.S. Pat. No. 9,031,680, the contents of which are hereby incorporated by reference.

Reference is now made to FIGS. 4A-B which are schematic illustrations showing waste collection system 136 in greater detail, in accordance with some embodiments of the present invention. FIG. 4A is a perspective view of system 136, and FIG. 4B is a cross-sectional view along the line B-B of FIG. 4A. Waste collection system 136 is useful for collecting waste liquid picked up from newly formed layers during the leveling of these layers in the course of a three-dimensional printing process, and can therefore be configured to collect the waste liquid from any leveling device of a three-dimensional printing system, such as, but not limited to, leveling device 32 of system 10 or system 110.

Waste collecting system 136 comprises waste collecting bath 200 for collecting liquid waste 202 from the leveling device (not shown, see device 32 in FIGS. 1A, 1B, 1D). A bath cover 204 covers bath from above so that the interior 206 of bath 204 is substantially isolated from the outside of bath 204. Bath 200 collects liquid waste 202 from the leveling device by means of a blade 203. In some embodiments of the present invention bath cover 204 seals bath 200, except for an interface 209 between cover 204 and blade 203 which is not sealed to allow the liquid waste to flow over blade 203 into bath 200.

System 136 comprises a waste removal pipe 208 sealingly passing through cover 204 so that the lumen 210 of pipe 208 is in fluid communication with the interior 206 of bath 204.

The proximal end 212 of pipe 208 is connected to a pump 220 (not shown, see FIGS. 1A and 1B), that is optionally and preferably controlled by the controller of the three-dimensional printing system (e.g., controller 20 of system 10 or 110). Pipe 208 is configured to generate under-pressure in the interior 206 of bath 204 by establishing fluid communication between pump 220 and interior 206. The generated under pressure sucks the liquid waste 202 out of bath 200 into the lumen 210 of pipe 208. In some embodiments of the present invention the interface 209 is sufficiently narrow so that when pump 220 is activated while blade 203 is loaded by liquid waste just removed from the leveling device, interface 209 is temporarily blocks by the liquid waste on blade 203, creating vacuum conditions in the interior 206 of bath 200, thus improving the efficiency of the suctioning.

The distal end 213 of pipe 208 that passes through cover 204, is optionally and preferably straight. Parts of pipe 208 that are above the straight end 213 may include knees 207 or be otherwise curved. Typically, pipe 208 is connected to cover 204 by a connector 205 such as an O-ring or the like, so that cover 204 and pipe 208 can be manufactured separately and be assembled before installing system 136 in the printing system.

The advantage of system 136 is that it creates an under-pressure throughout the interior 206 of bath 200. This is unlike conventional techniques in which the suction is applied only locally, leaving remnants of liquid waste at locations within the bath that are away from the suctioning point. Such an incomplete removal of the liquid waste creates a problem because the waste may solidify in the bath making it more difficult to remove it. Solidified waste in the bath can also form pockets which further prevent suctioning of newly arrived liquid waste because the pockets may block its direct flow path into the suctioning pipe. As a result, the amount of unremovable waste in the bath aggregates with time.

In some embodiments of the present invention waste collecting system 136 comprises a manifold 214 having an outlet port 216 connected to waste removal pipe 208, and a plurality of inlet ports 218 in fluid communication with the interior 206 of bath 200. The manifold establishes fluid communication between the lumen 210 of pipe 208 and each of the outlet ports and so in these embodiments, the under-pressure is generated at each of the inlet ports 218. Preferably, a plurality of secondary pipes 220 are employed by the manifold 214 so that the proximal side 222 of each secondary pipe 220 is connected to one of the inlet ports 218 and the distal side 224 of each secondary pipe 220 contacts the liquid waste 202 in bath 200. One or more, preferably all, of secondary pipes 220 are straight. The advantage of this embodiment is that it simplifies the manufacturing process and also improves the flow of the liquid waste into the outlet port 216 of manifold 214. In some embodiments of the present invention one or more of secondary pipes 202, more preferably each of secondary pipes 202, has a uniform diameter along its entire length. This is advantage because it further improves the flow of the liquid waste through the secondary pipes 202.

Manifold 214 can have any number of outlet ports and any respective number of secondary pipes. In the embodiment illustrated in FIG. 4B, which is preferred, but is not to be considered as limiting, manifold 214 includes two inlet ports.

Bath 200 of system 136 is preferably elongated and extends over a length that is approximately the same as the length of the roller or blade employed by the leveling device 32.

As used herein the term “about” refers to ±10%

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1. A waste collecting system for a leveling device of a three-dimensional printing system, the waste collecting system comprising a bath for collecting liquid waste from said leveling device, a bath cover covering said bath, and a waste removal pipe sealingly passing through said cover and being configured to generate under-pressure in an interior of said bath so as to suck said liquid waste out of said bath.

2. The system according to claim 1, comprising a manifold having an outlet port connected to said waste removal pipe, and a plurality of inlet ports in fluid communication with said interior, wherein said under-pressure is generated at each of said plurality of inlet ports.

3. The system according to claim 2, comprising a plurality of secondary pipes, each having a proximal side connected to one of said inlet ports and being positioned such that a distal side thereof contacts said liquid waste in said bath.

4. The system according to claim 3, wherein at least one of said secondary pipes is straight.

5. The system according to claim 3, wherein all said secondary pipes are straight.

6. The system according to claim 3, wherein at least one of said secondary pipes has a uniform diameter along its entire length.

7. (canceled)

8. The system according to claim 2, wherein said manifold includes no more than two inlet ports.

9. The system according to claim 1, comprising a connector for connecting said waste removal pipe to said cover.

10. The system according to claim 9, wherein said connector is an O-ring.

11. A system for three-dimensional printing, comprising:
an array of nozzles for dispensing building materials in layers;
a leveling device configured for leveling newly formed layers;
the waste collecting system according to claim 1;
a pump system connected to said pipe; and
a computerized controller configured for operating at least said array of nozzles.

12. The system according to claim 11, wherein said controller is configured to activate and deactivate said pump.

13. A method of collecting liquid waste from a leveling device of a three-dimensional printing system, the method comprises applying under-pressure to a waste removal pipe sealingly passing through a sealed cover of a bath collecting the liquid waste from said leveling device, so as to suck said liquid waste out of said bath.

14. The method according to claim 13, wherein said waste removal pipe is connected to an outlet port of a manifold, wherein said manifold comprises a plurality of inlet ports in fluid communication with an interior of said bath, and wherein said under-pressure is generated at each of said plurality of inlet ports.

15. The method according to claim 14, each inlet port is connected to proximal side of a secondary pipe having a distal side contacting said liquid waste in said bath.

16. The method according to claim 15, wherein at least one of said secondary pipes is straight.

17. (canceled)

18. The method according to claim 15, wherein at least one of said secondary pipes has a uniform diameter along its entire length.

19. (canceled)

20. The method according to claim 14, wherein said manifold includes no more than two inlet ports.

21. The method according to claim 13, wherein said waste removal pipe is connected to said cover by a connector.

22. The method according to claim 21, wherein said connector is an O-ring.

23. A method of three-dimensional printing, comprising:
dispensing a modeling material to form a plurality of layers arranged in a configured pattern corresponding to a shape of an object;
leveling at least one of said layers by a leveling device;
collecting liquid waste from said leveling device into a bath; and
executing the method according to claim 13, to remove said liquid waste from said bath.
